(19) United States
(12) Patent Application Publication
(10) Pub. No.: US 2008/0102752 A1
(43) Pub. Date: May 1, 2008

(54) Multiple satellite mobile system using multiple antennas

(75) Inventor: Sean S. Lee, Rockville, MD (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: The DirecTV Group, Inc.

(21) Appl. No.: 11/591,665

(22) Filed: Oct. 30, 2006

(51) Int. Cl. H04H 1/00; H04B 7/185; H04Q 7/20

(52) U.S. Cl. 455/12.1; 455/3.02; 455/427

(57) ABSTRACT

A communication system 10 includes a plurality of satellite antennas 26A-26n and a plurality of receivers 28A-28n that generate a plurality of channel requests. A switch 27 is in communication with the plurality of receivers 28A-28n and the plurality of satellite antennas 26A-26n. The switch 27 has a plurality of inputs 27I corresponding to the plurality of antennas and a plurality of outputs 27o corresponding to the plurality of receivers. The first output comprises a first channel from the first satellite and the second output comprises a second channel from the second satellite.

### TECHNICAL FIELD

The present invention relates generally to a mobile satellite system and, more particularly, to a mobile satellite system in which the vehicle includes multiple antennas.

### BACKGROUND

The statements in this section merely provide background information related to the present disclosure and may not constitute prior art.

Satellite television has become increasingly popular due to its wide variety of programming. Current DIRECTV systems employ an antenna as fixed to a structure. The antenna is pointed once and is secured in place.

One after-market manufacturer provides a tracking antenna used in a vehicle to track the satellite so that satellite programming may be enjoyed by the vehicle passengers. This system tracks a satellite and, therefore, displays channels from the satellite to the occupants. It is important to note that only channels carried by the satellite being tracked can be displayed.

Providing satellite programming to other types of vehicles such as trains, buses, planes, and ships may also be desirable for the same reasons that satellite programming has become popular in home-based systems. In addition, vehicles cannot be physically connected to a wire and, therefore, the wireless satellite system is a logical choice.

One problem with current home-based satellite systems is that one set top box is used to control the satellite. In a multiple television application, a master satellite control box allows one satellite to be utilized while the slave top boxes are limited to viewing channels from that one satellite.

It would, therefore, be desirable to provide a communication system that allows satellite TV to be enjoyed by multiple users with programming from multiple satellites.

### SUMMARY

In one aspect of the invention, a communication system includes a plurality of satellite antennas, a plurality of receivers generating a plurality of channel requests and a switch in communication with the plurality of receivers and the plurality of satellite antennas. The switch has a plurality of inputs corresponding to the plurality of antennas and a plurality of outputs corresponding to the plurality of receivers. The first output comprises a first channel from a first satellite and a second output comprises a second output from the second satellite.

In a further aspect of the invention, a communication system includes a first satellite, a second satellite and a vehicle that includes a first tracking antenna tracking the first satellite, a second tracking antenna tracking the second satellite, a first receiver coupled to the switch and generating a first channel request, a second receiver coupled to the switch and generating a second channel request. A switch is in communication with the first antenna, the second antenna, the first receiver and the second receiver. The switch has a plurality of inputs corresponding to the plurality of antennas and a plurality of outputs corresponding to the plurality of receivers. The first output comprises a first channel from a first satellite and a second output comprises a second channel from a second satellite.

Another feature of the disclosure includes a method of operating a communication system in a vehicle that includes communicating a first communication signal to a first antenna from a first satellite, communicating a second communication signal to a second antenna from a second satellite, generating a first channel request from a first receiver for a first channel on the first satellite and communicating the first channel request to a switch. The method also includes generating a second channel request from a second receiver for a second channel on the second satellite, communicating the second channel request to the switch, switching a first switch output to the first channel, and switching a second switch output to a second channel.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a system level view of a satellite broadcasting system according to the present invention.

FIG. 2 is a block diagrammatic view of a vehicle having a receiving system according to the present invention.

FIG. 3 is a schematic view of a switch 27 of FIG. 2.

FIG. 4 is a diagram of a communication signal used in the disclosure.

FIG. 5 is a flow chart illustrating a method of operating a communication system.

### DETAILED DESCRIPTION

The following description is merely exemplary in nature and is not intended to limit the present disclosure, application, or uses. In the following figures the same reference numerals will be used for the same features in the various views. The following figures are described with respect to a mobile satellite television system. The following example is set forth with respect to a mobile system for multiple viewers. Although not limited thereto, the teaching of this disclosure may be implemented in various types of vehicles including SUVs, vans, recreational vehicles, ships, trains, airplanes, buses or other systems in which more than one channel is to be used simultaneously from more than one satellite.

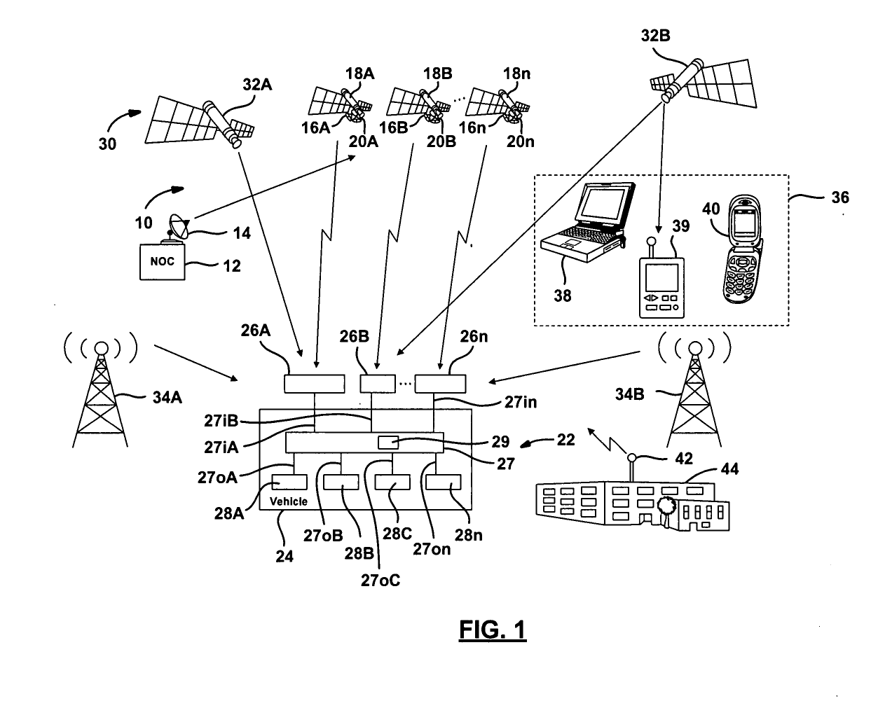

Referring now to FIG. 1, a satellite television broadcasting system 10 is illustrated. The satellite television broadcasting system 10 includes a network operations center 12 that generates wireless signals through a transmitting antenna 14 which are received by receiving antenna 16A-n of satellites 18A-n. The wireless signals, for example, may be digital signals such as digital television, audio or data signals. Transmitting antennas 20A-n generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within a vehicle 24. As mentioned above, the vehicle 24 may include various types of vehicles including SUVs, vans, buses, ships, trains, airplanes, and other vehicles in which more than one satellite may be used.

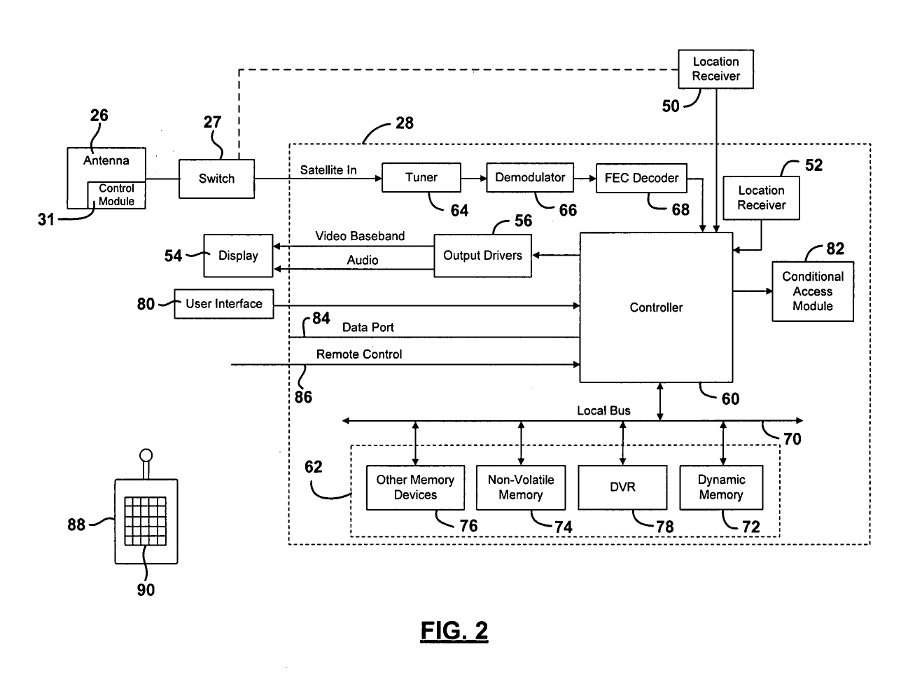

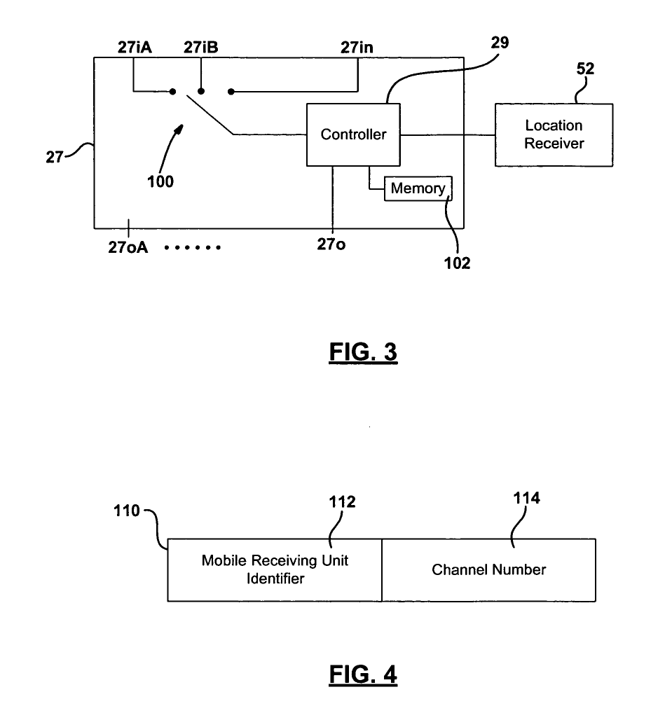

The mobile receiving system 22 and the vehicle 24 therein include multiple receiving antennas 26A-26n. The number of antennas 26A-26n corresponds to the number of satellites 28A-28n from which signals are to be simultaneously received. Each of the antennas 26A-26n is coupled to a switch 27. That is, each of the antennas 26A-26n is coupled to a respective input port 27iA-27 in. The switch 27 has output port 27oA-27 on coupled to a respective mobile receiving unit 28A-28n. Depending on the type of vehicle 24, various numbers of mobile receiving units 28 will be provided. For a cruise ship, the mobile receiving units 28 may be located in each cabin. For a bus, train or airplane, the mobile receiving units 28 may be located in a seatback or the like. A controller such as a microprocessor, discrete circuit, ASIC or the like may be provided in switch 27 to control the switching of the inputs and outputs. The mobile receiving unit 28 and the switch 27 will be further described below in FIGS. 2 and 3, respectively.

The system 10 receives location signals from a GPS system 30 that includes a first satellite 32A and a second satellite 32B. Although only two satellites are shown, a typical GPS system includes several satellites, several of which may be in view at any particular time. Triangulation techniques may be used to determine the elevation, latitude and longitude of the system. A locating system may also include cellular towers 34A and 34B that may be used by the mobile receiving system 22 to determine a location. Cellular phones typically include a GPS locating system. As the vehicle 24 moves about, the exact coordinates in latitude and longitude may be used to determine the proper designated marketing area for local television and broadcasting.

The present disclosure may also be used for displaying or utilizing various wireless information on a personal mobile device 36, such as a laptop computer 38, a personal digital assistant 39, and a cellular telephone 40. It should be noted that these devices and the automotive-based devices may also receive wireless signals having various types of information associated therewith from the cellular towers 34A and 34B. Other types of information may be broadcast from various other types of broadcasting areas such as an antenna 42 on a building 44. The building 44 may be various types of buildings such as a store and the wireless information transmitted from the antenna 42 may be advertising information. The wireless signals may include location information transmitted therewith. As will be described below, the information may be coded digitally into the signals. Thus, by reviewing the location information, signals appropriate for the location of the mobile devices may be displayed on the various devices.

Referring now to FIG. 2, a receiving system 22 is illustrated in further detail. Only one antenna 26 and one receiving device 28 are illustrated for simplicity. Many of both may be present as shown in FIG. 1. Antenna 26 may be various types of antennas including a tracking antenna that moves or rotates to track the relative movement of the satellite or other transponding devices with respect to the vehicle. The antenna 26 may also be an electronic antenna. The antenna 26 may two-way communicate information to the mobile receiving unit 28 regarding its status such as a locked-on state, tuning state, seeking state or the like.

The antenna 26 may include a control module 31 that controls the communication with the switch 27 and the receiving unit 28 and controls the movement to track the desired satellite.

The mobile receiver unit 28 may be coupled to antenna 26 with a two-way communication channel such as a wired or a wireless system. The switch 27 or the mobile receiving unit 28 may also include a location receiver 52 integrated therein. The location receiver 52 may be a GPS receiver. In a preferred embodiment, only one location receiver 50, 52 may be provided in the system. However, the location receiver 50, 52 may be part of the vehicle 24 or may be part of or in communication with the mobile receiving system 22 or part of the switch 27. The controller 60 or controller 29 may be coupled directly to location receiver 52 and/or location receiver 50.

The mobile receiving unit 28 is in communication with a display 54. The display 54 may be incorporated into the device 36 or within the vehicle 24. The display 54 may include output drivers 56 used for generating the desired audio and video outputs suitable for the particular display 54.

A controller 60 may be a general processor such as a microprocessor. The controller 60 may be used to coordinate and control the various functions of the receiving unit 28. These functions may include a tuner 64, a demodulator 66, a forward error correction decoder 68 and any buffers and other functions. The tuner 64 receives the signal or data from the individual channel. Tuner 64 also communicates the desired channel to the switch 27 as will be described below so that the switch 27 makes the proper connection. The demodulator 66 demodulates the signal or data to form a demodulated signal or data. The decoder 68 decodes the demodulated signal to form decoded data or a decoded signal. The controller 60 may be similar to that found in current DirecTV set top boxes which employ a chip-based multifunctional controller.

The controller 60 may include or be coupled to a local bus 70. The local bus 70 may be used to couple a dynamic memory 72 such as RAM which changes often and whose contents may be lost upon the interruption of power or boot up. The bus 70 may also be coupled to a non-volatile memory 74. The non-volatile memory may be an in-circuit programmable type memory. One example of a non-volatile memory is an EEPROM. One specific type of EEPROM is flash memory. Flash memory is suitable since it is sectored into blocks of data segments that may be individually erased and rewritten.

Other memory devices 76 may also be coupled to local bus 70. The other memory devices may include other types of dynamic memory, non-volatile memory, or may include such devices such as a digital video recorder. The display 54 may be changed under the control of controller 60 in response to the data in the dynamic memory 72 or non-volatile memory 74. A digital video recorder (DVR) 78 may also be coupled to the local bus as a memory for storing programming thereon.

The controller 60 may also be coupled to a user interface 80. User interface 80 may be various types of user interfaces such as a keyboard, push buttons, a touch screen, a voice activated interface, or the like. User interface 80 may be used to select a channel, select various information, change the volume, change the display appearance, or other functions. The user interface 80 is illustrated as part of the mobile receiving unit. However, should the unit be incorporated into a vehicle, the user interface 80 may be located external to the mobile receiving unit such as dial buttons, voice activated system, or the like incorporated into the vehicle and interface with the mobile receiving unit.

A remote control input 86 in communication with a remote control 88 having a keypad or other user interface may be used. The remote control 88 communicates control signals to the remote control input 86, which in turn provides various data to the controller 60.

A conditional access module card 82 (CAM) may also be incorporated into the mobile receiving unit. Access cards such as a conditional access module (CAM) cards are typically found in DirecTV units. The access card 82 may provide conditional access to various channels and wireless signals generated by the system. Not having an access card or not having an up-to-date access card 66 may prevent the user from receiving or displaying various wireless content from the system.

An external data port 84 may be coupled to the controller 60 for transmitting or receiving information from a device. The receiving device is illustrated having a data port 84 that is coupled to antenna 26. The connection between the data port 84 and the antenna 26 may be one of a number of types of connections including an RS 232 type connection, a USB connection, a wired connection, a wireless connection or the like. A dedicated port from controller 60 may be used to communicate in addition to other data ports.

Referring now to FIG. 3, a more detailed version of switch 27 is illustrated. As mentioned above, switch 27 includes controller 29. Also as mentioned above, the controller 29 may also be coupled to one of the location receivers 52. It should be noted that the location receiver 52 may be coupled to the controller 29 or coupled to each of the user devices. In a multiple user setting, it may be desirable to provide one location receiver for the entire system. Thus, the location receiver 52 may be coupled to the switch 27.

Controller 29 receives channel requests from the various receiving units through ports 27oA-27 on. Only one connection is illustrated for simplicity. The controller 29, in response to the channel request, controls a switch 100. The switch 100 may be a physical discrete switch, a software switch or other types of switches. The switch is preferably capable of coupling the port 27o to each of the antenna inputs 27iA-27in. Thus, the number of switch positions of switch 100 varies depending on the number of antennas. As the desired channel request is received by the controller 29, the switch position is changed or maintained depending on the location of the channel. The controller 29 may include a memory 102 that is used to store the channel switch position and satellite so that the proper switch position for the proper satellite and channel may be selected.

The switch 100 may be a physical switch, a software switch or an electronic switch. Multiple independent switches are likely in an implementation.

Referring now to FIG. 4, the receiving unit may generate a communication signal 110 that includes a mobile receiving unit identifier portion 112 and a channel number or channel request portion 114. The communication signal 110 allows the controller 29 of FIG. 3 to configure the switch so that the proper output is provided based upon the channel number 114.

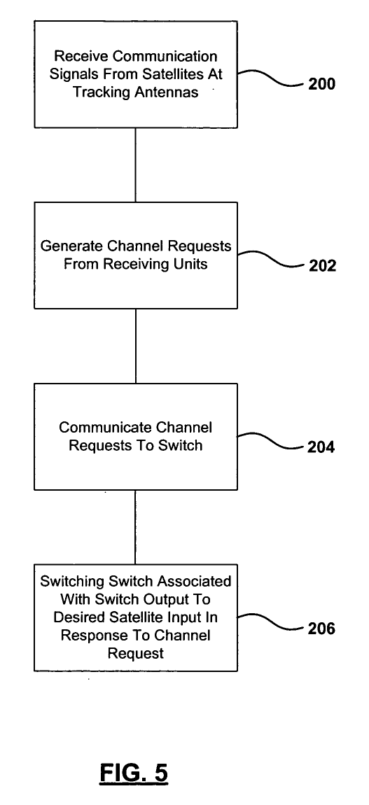

Referring now to FIGS. 3 and 5, a method of operating a communication system in a vehicle includes receiving communication signals from satellites at tracking antennas in step 200. In step 202, channel requests from various receiving units such as a first and a second receiving unit are received. In step 204, the channel requests are communicated to the switch. The channel requests may be performed at various times including simultaneously.

In step 206, the switch 27 receives the channel requests from the various ports (27o) on the switch. For example, a first and a second channel request may be provided from different receiving units. Those skilled in the art will recognize various numbers of channel requests may be simultaneously received. A switch 100 is associated with each of the ports. When the channel number and the satellite associated with the channel number are determined in the controller 29, the switch 100 is configured in the proper position so that the proper channel from the respective satellite is communicated to the output port of the switch and ultimately to the receiving device that initiated the channel request.

The following description is merely exemplary in nature and is not intended to limit the present disclosure, application, or uses. It should be understood that throughout the drawings, corresponding reference numerals indicate like or corresponding parts and features.

What is claimed is:

1. A communication system comprising:
a plurality of satellite antennas;
a plurality of receivers generating a plurality of channel requests; and
a switch in communication with the plurality of receivers and the plurality of satellite antennas, said switch having a plurality of inputs corresponding to the plurality of antennas and a plurality of outputs corresponding to the plurality of receivers, wherein a first output comprises a first channel from a first satellite and a second output comprises a second channel from a second satellite.

2. A communication system as recited in claim 1 wherein said first output and said second output is generated simultaneously.

3. A communication system as recited in claim 1 wherein the plurality of satellite antennas are each coupled to different satellites.

4. A communication system as recited in claim 1 wherein the plurality of satellite antennas comprise a plurality of tracking antennas.

5. A communication system as recited in claim 1 wherein the tracking antennas comprises a plurality of rotating antennas.

6. A communication system as recited in claim 1 further comprising a vehicle and wherein the plurality of satellite antennas, the plurality of receivers and the switch are coupled to the vehicle.

7. A communication system as recited in claim 6 wherein the vehicle comprises a ship.

8. A communication system as recited in claim 6 wherein the vehicle comprises a train.

9. A communication system as recited in claim 6 wherein the vehicle comprises a bus.

10. A communication system as recited in claim 6 wherein the vehicle comprises a plane.

11. A communication system comprising:
a first satellite,
a second satellite;
a vehicle comprising,
a first tracking antenna tracking the first satellite receiving a first satellite signal;
a second tracking antenna tracking the second satellite receiving a second satellite signal;
a first receiver coupled to the switch and generating a first channel request;
a second receiver coupled to the switch and generating a second channel request; and
a switch in communication with the first antenna, the second antenna, the first receiver and second receiver, said switch having a plurality of inputs corresponding to the plurality of antennas and a plurality of outputs corresponding to the plurality of receivers, wherein at a first output comprises a first channel from a first satellite and a second output comprises a second channel from a second satellite.

12. A communication system as recited in claim 11 wherein the first output and second output is generated simultaneously.

13. A communication system as recited in claim 11 wherein the first tracking antenna and the second tracking antenna comprise rotating antennas.

14. A communication system as recited in claim 11 further comprising a vehicle and wherein the plurality of satellite antennas, the plurality of receivers and the switch are coupled to the vehicle.

15. A communication system as recited in claim 11 wherein the vehicle comprises a ship.

16. A communication system as recited in claim 11 wherein the vehicle comprises a train.

17. A communication system as recited in claim 11 wherein the vehicle comprises a bus.

18. A communication system as recited in claim 6 wherein the vehicle comprises a plane.

19. A method of operating a communication system in a vehicle comprising:
communicating a first communication signal to a first antenna from a first satellite;
communicating a second communication signal to a second antenna from a second satellite;
generating a first channel request from a first receiver for a first channel on the first satellite;
communicating the first channel request to a switch;
generating a second channel request from a second receiver for a second channel on the second satellite;
communicating the second channel request to the switch;
switching a first switch output to the first communication signal including the first channel; and
switching a second switch output to the second communication signal including the second channel.

20. A method as recited in claim 19 further comprising tracking a first satellite with a first antenna, tracking a second satellite with a second antenna and coupling the first antenna and a second antenna to the switch.

21. A method as recited in claim 19 further comprising providing the first receiver, second receiver switch and in a vehicle.

22. A method as recited in claim 21 wherein the vehicle comprises a ship.

23. A method as recited in claim 21 wherein the vehicle comprises a train.

24. A method as recited in claim 21 wherein the vehicle comprises a bus.

25. A method as recited in claim 21 wherein the vehicle comprises a plane.
